(19) United States
(12) Patent Application Publication
(10) Pub. No.: US 2006/0047230 A1
(43) Pub. Date: Mar. 2, 2006

(54) Non-invasive apparatus and method for vibrational treatment of internal organs

(76) Inventor: Roger Talish, Hillsborough, NJ (US)

Correspondence Address: Carter, DeLuca, Farrell & Schmidt, LLP, Suite 225, 445 Broad Hollow Road, Melville, NY, 11747, US

(21) Appl. No.: 11/207,335

(22) Filed: Aug. 18, 2005

Related U.S. Application Data
(60) Provisional application No. 60/602,495, filed on Aug. 18, 2004.

(51) Int. Cl. A61H 1/00

(52) U.S. Cl. 601/46; 601/49

(57) ABSTRACT

Non-invasive apparatuses and methods are provided for treating internal organs using vibrations or vibratory energy.

### PRIORITY

This application claims priority to a United States provisional application filed on Aug. 18, 2004 and assigned U.S. Provisional Application Ser. No. 60/602,495; the entire contents of the provisional application are incorporated herein by reference.

### BACKGROUND

1. Technical Field

This disclosure relates to a medical treatment procedure. More particularly, the disclosure relates to a non-invasive apparatus and method for treating internal organs.

2. Description of the Related Art

A method of using resonant vibrations for treating postural instability is described in U.S. Pat. No. 6,607,497 B2. The method includes the steps of (a) providing a vibration table having a non-rigidly supported platform; (b) permitting the patient to rest on the non-rigidly supported platform for a predetermined period of time; and (c) repeating the steps (a) and (b) over a predetermined treatment duration. Step (b) includes the steps of (b 1) measuring a vibrational response of the patient's musculoskeletal system using a vibration measurement device; (b2) performing a frequency decomposition of the vibrational response to quantify the vibrational response into specific vibrational spectra; and (b3) analyzing the vibrational spectra to evaluate at least postural stability.

The method described in U.S. Pat. No. 6,607,497 B2 entails the patient standing on the vibration table or unstable standing platform which includes at least one accelerometer mounted to the outboard side thereof. The patient is then exposed to a vibrational stimulus by the unstable standing platform. The unstable standing platform causes a vibrational perturbation of the patient's neuro-sensory control system. The vibrational perturbation causes signals to be generated within at least one of the patient's muscles to create a measurable response from the musculoskeletal system. These steps are repeated over a predetermined treatment duration for approximately ten minutes a day in an effort to improve the postural stability of the patient.

The present disclosure describes a non-invasive apparatus and method for treating internal organs using resonant vibrations or a vibrational stimulus produced by vibration table similar to the vibration table described in U.S. Pat. No. 6,607,497 B2. A non-invasive apparatus and method are also herein described by the present disclosure for focusing energy from at least one energy moving device (e.g., speakers, air moving devices (blowers and fans), and sub-woofers) for treating internal organs. The vibrational treatment provided by the latter non-invasive apparatus and method can be provided in tandem with or separate from the vibrational treatment provided by the former non-invasive apparatus and method.

### SUMMARY

The present disclosure describes a non-invasive apparatus and method for vibrational treatment of internal organs in accordance with a first, second and third embodiment. The apparatus and method in accordance with the embodiments are typically employed following a determination that vibrational treatment of a patient's internal organs would produce a beneficial result. An example where vibrational treatment of internal organs may be warranted is to treat a patient who has cystic fibrosis. For example, the resonant vibrations or vibrational stimulus produced by a vibration table of the first embodiment of the inventive apparatus cause phlegm in the cystic fibrosis patient's lungs to break-up. Another example where vibrational treatment of internal organs may be warranted is to break-up kidney and gall bladder stones. In this case, the patient's kidney or gall bladder is subjected to a vibrational stimulus to break-up the kidney and gall bladder stones. An additional example where vibrational treatment of internal organs may be warranted is to treat a patient with Crohn's disease, an inflammatory bowel disease which causes inflammation in the small intestine.

The vibrational stimulus can also be provided by at least one energy moving device (e.g., speakers, air moving devices (blowers and fans), and sub-woofers) of the second embodiment. The vibrational treatment provided by the at least one energy moving device of the second embodiment can be provided in tandem with (e.g., simultaneously with the subjecting step) or separate from the vibrational treatment provided by the vibration table of the first embodiment.

In particular, the present disclosure, according to the first embodiment, relates to a non-invasive apparatus and method for vibrational treatment of internal organs. The apparatus includes a vibration table configured to vibrate for subjecting at least one patient organ to a vibrational stimulus while the patient is standing on the vibration table. The vibration table preferably vibrates to produce resonant vibrations having a frequency in the range of 1 Hz to 100 KHz, and preferably from 1 Hz to 10 KHz. The resonant vibrations provide the vibrational stimulus at substantially the same frequency to the at least one patient organ.

The method according to the first embodiment includes the steps of (a) subjecting a patient, including at least one patient organ, to a vibrational stimulus for a predetermined period of time; and (b) repeating step (a) over a predetermined treatment duration to treat the at least one patient organ. The method further includes the step of having the patient stand on a vibration table capable of vibrating for producing resonant vibrations having a frequency in the range of 1 Hz to 100 KHz, and preferably from 1 Hz to 10 KHz. The resonant vibrations provide the vibrational stimulus at substantially the same frequency to the at least one patient organ.

The method also includes the step of evaluating a healing response of the at least one patient organ and adjusting at least one of the predetermined period of time and the predetermined treatment duration accordingly. In the apparatus and method in accordance with the first embodiment of the present disclosure, the vibrational stimulus causes the patient and the at least one patient organ to shake or vibrate for producing a beneficial healing effect for the at least one patient organ.

Additionally, the present disclosure, according to the second embodiment, relates to a non-invasive apparatus and method for focusing energy from at least one energy moving device (e.g., speakers, air moving devices (blowers and fans) and sub-woofers) for treating internal organs. The vibrational treatment provided by the non-invasive apparatus and method can be provided in tandem with (e.g., simultaneously with the subjecting step) or separate from the vibrational treatment provided by the non-invasive apparatus and method of the first embodiment. The at least one energy moving device preferably generates waves having a frequency in the range of 1 Hz to 100 KHz, and preferably from 1 Hz to 10 KHz. The waves transmit vibratory energy which is focused towards the patient's torso by the non-invasive apparatus for vibrationally treating at least one patient organ.

In a third embodiment, the non-invasive apparatus and method for focusing energy from at least one energy moving device (e.g., speakers, air moving devices (blowers and fans) and sub-woofers) for treating internal organs, described in relations to the second embodiments may be mounted to a vibrational bed (i.e., a bed capable of vibrating) such that a patient is infirm while being subjected to vibratory energy generated by the at least one energy moving device.

The method according to the second and third embodiments includes the steps of (a) subjecting a patient, including at least one patient organ, to vibratory energy generated by at least one energy moving device for a predetermined period of time; and (b) repeating step (a) over a predetermined treatment duration to treat the at least one patient organ. The method can further include the step of having the patient stand on a vibration table, or lay on the vibrational bed, the table or the bed being capable of vibrating for producing resonant vibrations having a frequency in the range of 1 Hz to 100 KHz, and preferably from 1 Hz to 10 KHz, while subjecting the patient to the vibratory energy generated by the at least one energy moving device. The resonant vibrations provide a vibrational stimulus at substantially the same frequency to the at least one patient organ. Alternatively, the resonant vibrations provide a vibrational stimulus at different frequencies to the at least one patient organ.

The method also includes the step of evaluating a healing response of the at least one patient organ and adjusting at least one of the predetermined period of time and the predetermined treatment duration accordingly. In the apparatus and method in accordance with the second embodiment of the present disclosure, the vibrational stimulus causes the patient and the at least one patient organ to shake or vibrate for producing a beneficial healing effect for the at least one patient organ.

### BRIEF DESCRIPTION OF THE DRAWINGS

FIG. 1 is an isometric view showing a vibrating platform with a patient undergoing vibrational treatment for treating an organ in accordance with the method according to the first embodiment of the present disclosure;

FIG. 2 is a flow diagram showing the steps for treating a patient organ using a vibrational stimulus in accordance with the method according to the first embodiment of the present disclosure;

FIG. 3 is an isometric view showing a patient standing on the vibrating platform shown by FIG. 1 undergoing vibrational treatment for treating an organ as illustrated by FIG. 2 while having vibratory energy generated by at least one energy moving device and focused to the organ in accordance with the method according to the second embodiment of the present disclosure;

FIG. 4 is a flow diagram showing the steps for treating a patient organ using a vibrational stimulus in combination with vibratory energy generated by at least one energy moving device in accordance with the method according to the second embodiment of the present disclosure; and

FIG. 5 is an isometric view showing a patient laying on a vibrational bed, i.e., a bed capable of vibrating.

### DETAILED DESCRIPTION OF PREFERRED EMBODIMENTS

The present disclosure describes a non-invasive apparatus and method for vibrational treatment of internal organs in accordance with a first and a second embodiment. The apparatus and method according to the first and second embodiments are typically employed following a determination that vibrational treatment of a patient's internal organs would produce a beneficial result.

An example where vibrational treatment of a patient's internal organs may be warranted is to treat a patient who has cystic fibrosis. The resonant vibrations or vibrational stimulus produced by a vibration table of the apparatus in accordance with the first embodiment and/or vibratory energy generated by at least one energy moving device (e.g., speakers, air moving devices (blowers and fans) and sub-woofers) and focused to the patient's lungs in accordance with the second embodiments cause phlegm in the cystic fibrosis patient's lungs to break-up. Another example where vibrational treatment of internal organs may be warranted is to break-up kidney and gall bladder stones. In this case, the patient's kidney or gall bladder is subjected to a vibrational stimulus and/or vibratory energy generated by the at least one energy moving device to break-up the kidney and gall bladder stones. An additional example where vibrational treatment of internal organs may be warranted is to treat a patient with Crohn's disease, an inflammatory bowel disease which causes inflammation in the small intestine.

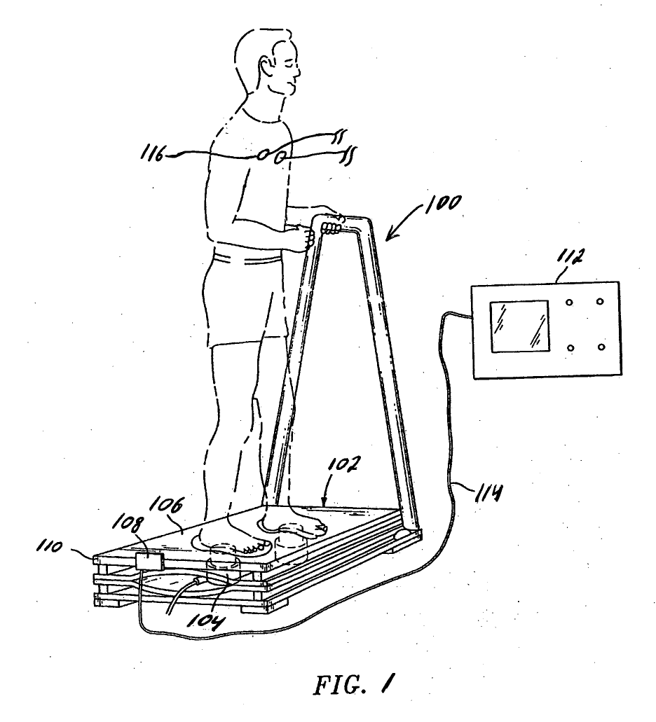

An exemplary apparatus of the present disclosure in accordance with the first embodiment is shown by FIG. 1 and designated generally by reference numeral 100. The apparatus 100 includes a vibration table 102 configured to vibrate for subjecting at least one patient organ to a vibrational stimulus while the patient is standing on the vibration table 102. The vibration table 102 preferably vibrates to produce resonant vibrations having a frequency in the range of 1 Hz to 100 KHz, and preferably from 1 Hz to 10 KHz. The resonant vibrations provide the vibrational stimulus at substantially the same frequency to the at least one patient organ. The vibration table 102 includes a motorized spring system having spring supports for causing the table 102 to vibrate at a controlled frequency.

The vibration table 102 imposes vertical vibration on the patient standing thereon. Vibrational treatment is preferably performed at a predetermined frequency for a predetermined period of time and for a predetermined treatment duration depending on one or more parameters. The parameters include which patient organ requires vibrational treatment, factors relating to the patient (age, sex, weight, postural stability, etc.), whether the patient has any abnormalities, and/or the condition of the patient and/or organ requiring vibrational treatment. Generally, the predetermined frequency is 30 Hz, the predetermined period of time is ten minutes and the predetermined treatment duration is approximately four weeks.

FIG. 1 shows a patient undergoing the treatment method according to the present disclosure. The patient stands on the vibration table 102. Vibrations, generated by table 102 for a predetermined period of time, for example, ten minutes, are transmitted through the patient's body and to the at least one patient organ requiring vibrational treatment. The vibrations are generated by motorized spring mechanisms 104 located underneath a standing platform 106 of the vibration table 102 and attached thereto. It is contemplated that the vibrations may be generated by a plurality of non-motorized springs or coils attached underneath the standing platform 106, upon which the standing platform 106 rests.

The frequencies imparted by vibration table 102 are in the range between 30-90 Hz with a peak amplitude between 0.04 and 0.4 g. Preferably, the frequency of the vibration table 102 is approximately 30 Hz and the peak amplitude is 0.2 g. The vibration waves are preferably sinusoidal, however other waveforms are contemplated.

At least one low-mass accelerometer 108 is mounted to the vibration table 102 on an outboard side 110 of the standing platform 106 as described in U.S. Pat. No. 6,607,497, the contents of which are incorporated herein by reference. Accelerometer 108 is used to measure the vibrational response of the patient's musculoskeletal system to simultaneously determine postural stability of the patient, if so desired, using the method described in U.S. Pat. No. 6,607,497, while providing vibrational treatment to the at least one patient organ in accordance with the present disclosure.

As described in U.S. Pat. No. 6,607,497, the vibrational response is measured and recorded by a spectrum analyzer/computer 112 which is electrically connected to the accelerometer 108 by a cable 114. The accelerometer response data is analyzed to extract information on postural sway. Preferably, the accelerometer 108 records the individual's natural sway pattern while the individual preferably stands in the Romberg position (feet separated at shoulder width, hands at side, and eyes open) for a preferable period of 10-100 seconds. If the accelerometer 108 is attached to the patient, then one can also analyze and extract information on muscle strength and the muscle to bone stimulus to determine any improvement in the patient's neuro-muscular status.

The method of the present disclosure according to the first embodiment includes the steps of (a) subjecting the patient, including the at least one patient organ, to a vibrational stimulus for a predetermined period of time; and (b) repeating the step (a) over a predetermined treatment duration to treat the at least one patient organ. The method further includes the step of having the patient stand on a vibration table capable of vibrating for producing resonant vibrations having a frequency in the range of 1 Hz to 500 Hz. Typically, the resonant vibrations provide the vibrational stimulus at substantially the same frequency to the at least one patient organ. The method also includes the step of evaluating a healing response of the at least one patient organ.

Preferably, the predetermined period of time is approximately ten minutes and the predetermined treatment duration is at least four weeks. In the apparatus and method of the present disclosure according to the first embodiment, the vibrational stimulus causes the at least one patient organ to shake or vibrate at a vibrational frequency for producing a beneficial healing effect.

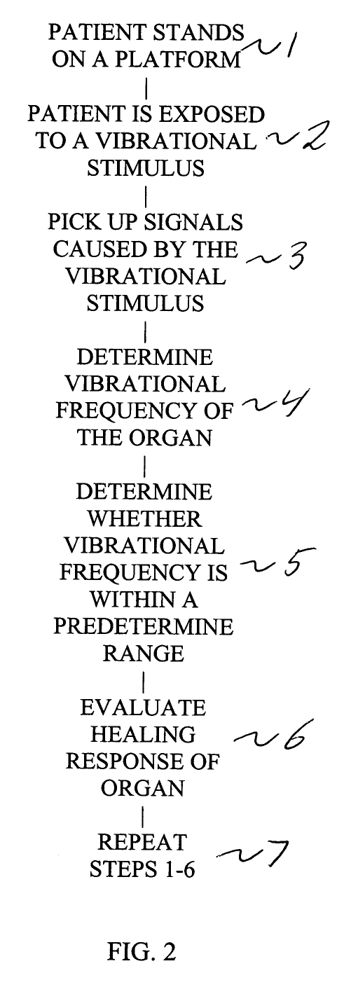

With reference to FIG. 2, there is shown a flow diagram of the vibrational treatment method for treating at least one patient organ in accordance with the first embodiment of the present disclosure. In step 1, the patient stands on a standing platform, such as the standing platform 106 shown by FIG. 1 which may include at least one accelerometer mounted to the outboard side thereof. In step 2, the patient is exposed to a vibrational stimulus by the standing platform 106. In step 3, the vibrational stimulus or perturbation causes signals to be generated within the at least one patient organ. The signals are preferably picked up by electrical receptors 116 (see FIG. 1) as are known in the art. The electrical receptors are placed on the patient's skin in proximity to the at least one patient organ.

Preferably, the patient stands on the standing platform for a predetermined period of time, e.g., 10 minutes, and the standing platform 106 is vibrated at approximately 30 Hz and at 0.2 g peak-to-peak.

Step 4 represents measuring/recording the signals picked up by the electrical receptors for recording organ vibrations and determining the vibrational frequency of the at least one patient organ. Thereafter, in step 5, a determination is made as to whether the vibrational frequency of the at least one patient organ is within a predetermined range for providing a beneficial response. The determination is made by correlating the vibrational frequency of the at least one patient organ with data, such as data obtained for individuals with similar characteristics to the patient, for example age, sex, body measurements, organ being treated, etc. Based on the determination, the vibrational frequency of the standing platform 106 is adjusted accordingly or kept constant.

Step 6 provides for evaluating a healing response of the at least one patient organ to determine if the condition of the at least one patient organ is improving and the abnormality and/or condition (kidney stones, phlegm in the lungs, etc.) is dissipating. Steps 5 and 6 are preferably performed using a computer running a custom program in order to access data stored within a database and/or data structure, e.g., look-up table, etc., for correlating the vibrational frequency of the at least one patient organ and evaluating the healing response.

Step 7 entails repeating steps 1-6, where the patient undergoes the procedure over a predetermined treatment duration. Preferably, the treatment duration is at least four weeks which can be adjusted according to the evaluation performed in step 6. Further, the predetermined period of time or the amount of time the patient stands on the platform during each treatment session can be adjusted according to the evaluation of the healing response performed in step 6.

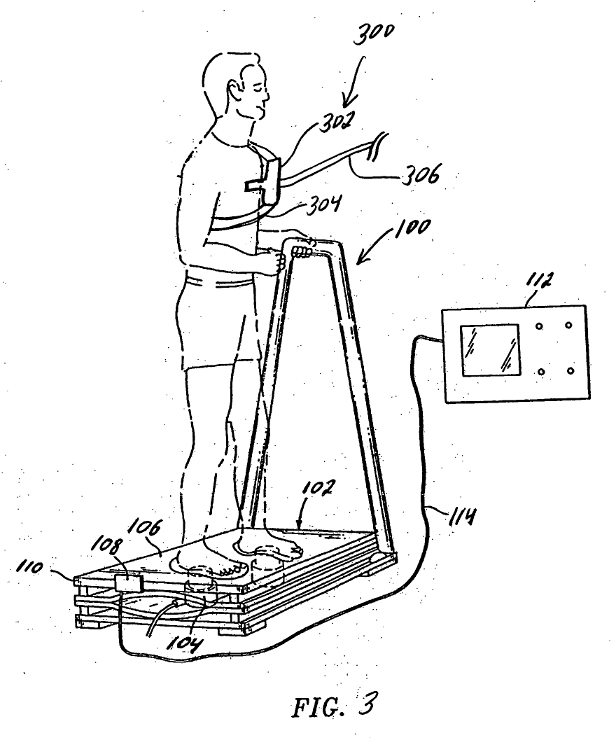

An exemplary apparatus of the present disclosure in accordance with the second embodiment is shown by FIG. 3 and designated generally by reference numeral 300. The apparatus 300 is shown mounted to a patient for generating and directing vibratory energy to the patient's torso for vibrational treatment of the at least one internal organ while the patient is simultaneously undergoing vibrational treatment for treating the at least one internal organ using the vibration table 102 of the apparatus 100 described above with reference to the first embodiment of the present disclosure. It is contemplated, however, that the apparatus 300 can be used separate and apart from the apparatus 100 for providing vibrational treatment of the at least one internal organ of the patient.

The apparatus 300 includes at least one energy moving device 302 which may be selected from the group consisting of speakers, air moving devices (blowers and fans) and sub-woofers, or combinations thereof. The energy moving device 302 is mounted to the patient using straps 304 and includes a cord 306 for plugging the energy moving device 302 to a power source.

During vibrational treatment, the energy moving device 302 generates vibratory energy which is focused to the at least one internal organ requiring vibrational treatment in accordance with the method of the second embodiment of the present disclosure. The at least one energy moving device 302 generates waves having a frequency in the range of 1 Hz to 100 KHz, and preferably from 1 Hz to 10 KHz. The waves, as the resonant vibrations described above, provide a vibrational stimulus at substantially the same frequency to the at least one patient organ.

Similarly to the method according to the first embodiment, vibrational treatment using the at least one energy moving device 302 is preferably performed at a predetermined frequency for a predetermined period of time and for a predetermined treatment duration depending on one or more parameters. The parameters include which patient organ requires vibrational treatment, factors relating to the patient (age, sex, weight, postural stability, etc.), whether the patient has any abnormalities, and/or the condition of the patient and/or organ requiring vibrational treatment. Generally, the predetermined frequency is 30 Hz, the predetermined period of time is ten minutes and the predetermined treatment duration is approximately four weeks.

Preferably, the at least one energy moving device 302 includes piezoelectric transducers for generating the low frequency waves for use in the vibrational treatment of at least one internal organ. In one preferred embodiment, piezoelectric transducers are used which make use of non-linear parametric acoustics as known in the art to facilitate the generation of the low frequency waves. This type of piezoelectric transducers takes advantage of the non-linear properties of the propagation medium.

In a second preferred embodiment, piezoelectric transducers are used which are fabricated using porous ceramic technology to generate the low frequency waves. This type of piezoelectric transducers take advantage of the intrinsic properties of the material used to fabricate the transducers.

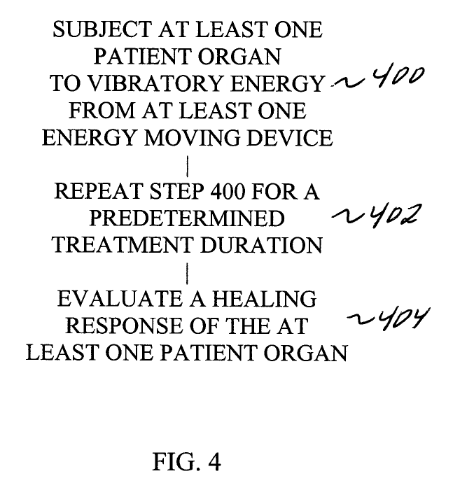

With reference to FIG. 4, the method of the present disclosure according to the second embodiment includes the steps of (a) subjecting a patient, including at least one patient organ, to vibratory energy generated by at least one energy moving device 302 for a predetermined period of time (step 400); and (b) repeating step (a) over a predetermined treatment duration to treat the at least one patient organ (step 402). The method can further include the step of having the patient stand on the vibration table 102 capable of vibrating for producing resonant vibrations having a frequency in the range of 1 Hz to 100 KHz, and preferably from 1 Hz to 10 KHz, while subjecting the patient to the vibratory energy generated by the at least one energy moving device 302. The resonant vibrations provide a vibrational stimulus at substantially the same frequency to the at least one patient organ.

The method also includes the step of evaluating a healing response of the at least one patient organ and adjusting at least one of the predetermined period of time and the predetermined treatment duration accordingly (step 404). In the apparatus and method in accordance with the second embodiment of the present disclosure, the vibrational stimulus provided by the vibratory energy causes the patient and the at least one patient organ to shake or vibrate for producing a beneficial healing effect for the at least one patient organ.

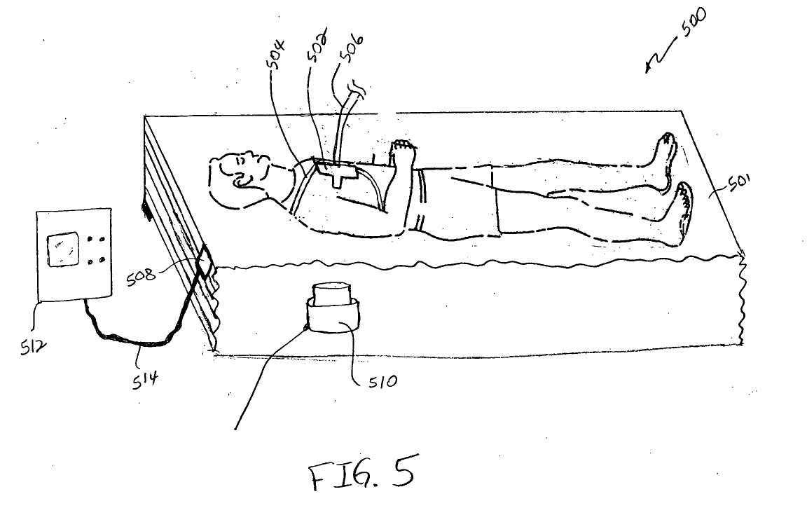

FIG. 5 illustrates the apparatus of the present disclosure in accordance with a third embodiment and is designated generally by reference numeral 500. Apparatus 500 is similar to apparatus 300 and will only be discussed in detail to the extent necessary to identify differences in construction and/or operation. In this particular embodiment, the apparatus 500 is shown mounted to a patient for generating and directing vibratory energy to the patient's torso for vibrational treatment of the at least one internal organ while the patient is laying on the vibrational bed 501.

The apparatus 500 includes at least one energy moving device 502 which may be selected from the group consisting of speakers, air moving devices (blowers and fans) and sub-woofers, or combination thereof. The energy moving device 502 is substantially similar to the energy moving device 302 of FIG. 3. The energy moving device 502 is mounted to the patient using straps 504 and includes a cord 506 for plugging the energy moving device 502 to a power source.

Preferably, the energy moving device 502 includes a plurality of speakers positioned near the organ to be treated. The plurality of speakers may generate low frequency waves in a manner described hereinabove with respect to the second embodiment. Moreover, each speaker may be configured to generate waves having a frequency different from the frequencies of the waves generated by the other speakers. Accordingly, an organ can be subjected to a vibrational stimulus produced by waves having frequencies. For example, during the treatment of a patient who has cystic fibrosis, a first lobe of the patient's lungs is vibrated by a wave having a frequency of 3.4 Hz and a second lobe is vibrated by a wave having a frequency of 4.3 Hz. Preferably, both lobes are vibrated at their respective resonance frequencies.

Moreover, an arrangement similar to the one described hereinabove with respect to the first embodiment is envisioned, wherein the patient is simultaneously undergoing vibrational treatment for treating the at least one internal organ using the vibrational bed 501. The vibrational bed 501 may be configured to vibrate for subjecting the at least one patient organ to a vibrational stimulus while the patient lays on the vibrational bed 501. The vibrational bed 501 includes a motorized spring system having spring supports for causing the bed to vibrate at a controlled frequency. The vibrations are generated by a motorized spring mechanism 510 located underneath the bed surface 501 and attached thereto. Accelerometer 508 is used to measure the vibrational response of the patient's musculoskeletal system to simultaneously determine postural stability of the patient, using the method described hereinabove.

As described hereinabove, the vibrational response is measured and recorded by a spectrum analyzer/computer 512 which is electrically connected to the accelerometer 508 by a cable 514.

The method of the present disclosure according to the third embodiment includes all the steps described in FIG. 4, except that the patient is laying on the vibrational bed 500 capable of vibrating for producing resonant vibrations in a manner described with reference to the first and second embodiment.

It is contemplated that the methods of the present disclosure, as the method described in U.S. Pat. No. 6,607,497, can further be carried out while the patient is sitting on the standing platform. Hence, the methods can thus be used in the treatment of the infirm elderly where other treatments are beyond the physical capabilities of these individuals.

Advantages provided by the methods of the present disclosure is that little or no training/learning is required of the patients; the apparatus utilized by each method is inexpensive to construct and their respective small size makes it convenient for storage and use; the frequency of vibrational loading of the standing platform can be easily adjusted to permit focused treatment on a specific patient organ, i.e., kidney, lung, gall bladder, heart, stomach, small intestine, etc.; the amplitude of vibrational loading of the standing platform can be easily controlled from 0.05 to 0.5 g; only a short duration of treatment is required for significant effect (ten minutes per day); the method in accordance with the first embodiment provides a sustained effect on postural stability while treating the patient organ, such that improved postural stability can be maintained with only weekly or twice weekly treatments; the ability to monitor postural stability in real-time during treatment using the methodology described in U.S. Pat. No. 6,607,497; the methods can be effected while the patient is in the standing or seated position; and the methods can be employed in the treatment of the infirm elderly where other treatments, including surgery, are beyond the physical capabilities of these individuals.

While the methods of the present disclosure according to the first, second and third embodiments utilize a vibrating platform or vibrational bed and at least one energy moving device, respectively, as the fundamental perturbing agents for vibrating the at least one patient organ, it is contemplated that any other apparatus or method can be employed for providing the vibrational stimulus required for vibrationally treating the at least one patient organ in accordance with the methodology of the first, second and third embodiments of the present disclosure.

1. A method for treating at least one patient organ, said method comprising:
(a) subjecting a patient, including the at least one patient organ, to a vibrational stimulus for a predetermined period of time; and
(b) repeating step (a) over a predetermined treatment duration to treat the at least one patient organ.

2. The method according to claim 2, further comprising having the patient stand on a vibration table capable of vibrating for producing resonant vibrations.

3. The method according to claim 1, wherein the resonant vibrations have a frequency in the range of 1 Hz to 100 KHz.

4. The method according to claim 2, wherein the resonant vibrations have a frequency in the range of 1 Hz to 10 KHz.

5. The method according to claim 2, wherein the resonant vibrations provide the vibrational stimulus at substantially the same frequency to the at least one patient organ.

6. The method according to claim 1, further comprising evaluating a healing response of the at least one patient organ and adjusting at least one of the predetermined period of time and the predetermined treatment duration accordingly.

7. The method according to claim 1, wherein the vibrational stimulus causes the at least one patient organ to vibrate for producing a beneficial healing effect for the at least one patient organ.

8. The method according to claim 1, wherein the subjecting step comprises:
providing at least one energy moving device capable of generating waves;
focusing the generated waves towards a patient's torso for treating the at least one patient organ.

9. A method for treating at least one patient organ, said method comprising:
providing at least one energy moving device capable of generating waves; and
focusing the generated waves towards a patient's torso for treating the at least one patient organ.

10. The method according to claim 9, further comprising:
(a) subjecting a patient, including the at least one patient organ, to a vibrational stimulus for a predetermined period of time; and
(b) repeating step (a) over a predetermined treatment duration to treat the at least one patient organ.

11. The method according to claim 9, wherein the at least one energy moving device generates waves having a frequency in the range of 1 Hz to 100 KHz.

12. The method according to claim 9, wherein the at least one energy moving device generates waves having a frequency in the range of 1 Hz to 10 KHz.

13. The method according to claim 9, wherein the at least one energy moving device is selected from the group consisting of speakers, air moving devices (blowers and fans), sub-woofers, and combinations thereof.

14. The method according to claim 9, wherein the at least one energy moving device is mounted to a vibrational bed.

15. The method according to claim 9, further comprising having the patient stand on a vibration table, or lay on a vibrational bed, the table or the bed being capable of vibrating for producing resonant vibrations.

16. The method according to claim 15, wherein the resonant vibrations have a frequency in the range of 1 Hz to 100 KHz.

17. The method according to claim 15, wherein the resonant vibrations have a frequency in the range of 1 Hz to 10 KHz.

18. A method for treating at least one patient organ, said method comprising:
(a) subjecting a patient, including the at least one patient organ, to vibratory energy generated by at least one energy moving device for a predetermined period of time; and
(b) repeating step (a) over a predetermined treatment duration to treat the at least one patient organ.

19. The method according to claim 18, wherein the at least one energy moving device is selected from the group consisting of speakers, air moving devices (blowers and fans), sub-woofers, and combinations thereof.

20. The method according to claim 18, further comprising evaluating a healing response of the at least one patient organ and adjusting at least one of the predetermined period of time and the predetermined treatment duration accordingly.

21. The method according to claim 18, further comprising having the patient stand on a vibration table, or lay on a vibrational bed, the table or the bed being capable of vibrating for producing resonant vibrations.
